(19) United States
(12) Patent Application Publication
(10) Pub. No.: US 2008/0061677 A1
(43) Pub. Date: Mar. 13, 2008

(54) ELECTRON EMISSION DEVICE, ELECTRON EMISSION TYPE BACKLIGHT UNIT INCLUDING ELECTRON EMISSION DEVICE, AND METHOD OF FABRICATING ELECTRON EMISSION DEVICE

(75) Inventors: Yoon-Jin KIM, Suwon-si (KR); Jae-Myung Kim, Suwon-si (KR); Hee-Sung Moon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/756,169

(22) Filed: May 31, 2007

(30) Foreign Application Priority Data
Sep. 11, 2006 (KR) 2006-87423

(51) Int. Cl. H01J 1/62; H01J 1/14; H01J 9/00

(52) U.S. Cl. 313/496; 313/346 R; 445/23

(57) ABSTRACT

An electron emission device to regularly emit electrons and a method of manufacturing the same. Also, an electron emission type backlight unit including the electron emission device in which a high voltage can be applied to an anode and required brightness can be obtained. In addition, the electron emission device can be manufactured using a simplified manufacturing process. The electron emission device includes a first electrode, a second electrode formed opposite the first electrode, and an electron emission layer which is electrically connected to one or each of the first and second electrodes and comprising carbide-derived carbon. The electron emission device may be a display device to form static or dynamic images.

### CROSS-REFERENCE TO RELATED PATENT APPLICATIONS

This application claims the benefit of Korean Application No. 2006-87423, filed Sep. 11, 2006, in the Korean Intellectual Property Office, the disclosure of which is incorporated herein in its entirety by reference.

### BACKGROUND OF THE INVENTION

1. Field of the Invention

Aspects of the present invention relate to an electron emission device, an electron emission type backlight unit, and a method of fabricating the electron emission device, and more particularly, to an electron emission device that regularly emits electrons, an electron emission type backlight unit including the electron emission device, and a method of fabricating the electron emission device.

2. Description of the Related Art

Generally, electron emission devices use a hot cathode or a cold cathode as an electron emission source. Examples of electron emission devices having a cold cathode include a field-emitter array (FEA) type, a surface conduction emitter (SCE) type, a metal insulator metal (MIM) type, a metal insulator semiconductor (MIS) type, and a ballistic electron surface emitting (BSE) type.

An FEA type electron emission device utilizes the principle that when a material with a low work function or a high β function is used as an electron emission source, electrons are easily emitted in a vacuum the application of an electric field. Devices including a tip structure primarily composed of Mo, Si, etc., and having a sharp end, and carbon-based materials such as graphite, diamond like carbon (DLC), etc., as electron emission sources have been developed. Recently, nanomaterials, such as nanotubes and nanowires, have been used as electron emission sources.

An SCE type electron emission device is formed by disposing a conductive thin film between a first electrode and a second electrode, which are arranged on a first substrate so as to face each other, and producing microcracks in the conductive thin film. When voltages are applied to the first and second electrodes and electric current flows along the surface of the conductive thin film, electrons are emitted from the microcracks thereby providing electron emission.

MIM type and MIS type electron emission devices include a metal-insulator-metal structure and a metal-insulator-semiconductor structure, respectively, as an electron emission source. When voltages are applied to the two metals in the MIM type or to the metal and the semiconductor in the MIS type, electrons are emitted while migrating and accelerating from the metal or the semiconductor having a high electron potential to the metal having a low electron potential.

A BSE type electron emission device utilizes the principle that when the size of a semiconductor is reduced to less than the mean free path of electrons in the semiconductor, electrons travel without scattering. An electron-supplying layer composed of a metal or a semiconductor is formed on an ohmic electrode, and then an insulating layer and a metal thin film are formed on the electron-supplying layer. When voltages are applied to the ohmic electrode and the metal thin film, electrons are emitted.

FIG. 1 is a partial cross-sectional view illustrating a conventional electron emission type backlight unit 100 including an electron emission device.

Referring FIG. 1, the conventional electron emission type backlight unit 100 includes an electron emission device 101 and a front panel 102. The front panel 102 includes a front substrate 90, an anode electrode 80 formed on a bottom surface of the front substrate 90 disposed between the front substrate 90 and the electron emission device 101, and a phosphor layer 70 coated on the anode electrode 80.

The electron emission device 101 includes a base substrate 10 formed parallel to the front substrate 90, a first stripe-type electrode 20 formed on the base substrate 10, a second stripe-type electrode 30 formed parallel to the first stripe-type electrode 20, and electron emission layers 40 and 50 formed around the first electrode 20 and the second electrode 30, respectively. An electron emission gap G is formed between the electron emission layers 40 and 50 surrounding the first electrode 20 and the second electrode 30.

A vacuum space 103 having a pressure less than atmospheric pressure is formed between the front panel 102 and the electron emission device 101. Spacers 60 are formed between the front panel 102 and the electron emission device 101 at predetermined intervals in order to maintain and resist the pressure generated by the vacuum formed between the front panel 102 and the electron emission device 101.

In the conventional electron emission device 100 described above, electrons are emitted from the electron emission layers 40 and 50 by electric fields generated between the first electrode 20 and the second electrode 30: That is, electrons are emitted from the electron emission layers 40 and 50 formed around an electrode functioning as a cathode selected from the first electrode 20 and the second electrode 30. The electrons are emitted towards an electrode functioning as an anode initially. However, the emitted electrons are accelerated towards the phosphor layer 70 due to the strong electric field produced by the anode electrode 80.

Since the electron emission layers 40 and 50 are usually formed of carbon-based materials having high aspect ratios, a plurality of electron emission materials irregularly extend toward the anode electrode 80. Accordingly, electron emission is not easily controlled by the electric field formed between the first electrode 20 and the second electrode 30. Diode emission, in which electrons are emitted by an electric field formed between an electrode functioning as a cathode selected from the first electrode 20 and the second electrode 30 of the electron emission device 101 and the anode electrode 80, occurs. In particular, hot spots or arc discharge may occur because of high voltage applied to the anode electrode 80 making it difficult to regularly emit electrons.

### SUMMARY OF THE INVENTION

Aspects of the present invention provide an electron emission device that regularly emits electrons. Aspects of the present invention also provide an electron emission type backlight unit including the electron emission device, in which a high voltage is applied to an anode and required brightness is obtained. In addition, aspects of the present invention provide a method of fabricating the simplified electron emission device.

According to an aspect of the present invention, there is provided an electron emission device including: a first electrode; a second electrode formed opposite the first electrode; and an electron emission layer comprising carbide-derived carbon and electrically connected to one or each of the first and second electrodes.

The mean diameter of nanopores formed in the carbide-derived carbon may be in the range of 0.4 through 5 nm.

The electron emission device may further include a resistance layer which is disposed between the electron emission layer and the one or each of the first and second electrodes electrically connected to the electron emission layer.

The resistance layer may include amorphous silicon or semiconductor carbon nanotubes.

The electron emission layer may be intermittently formed at predetermined intervals on one or each of the first electrode and the second electrode.

The electron emission layer may be intermittently formed at predetermined intervals on one or each of the first electrode and the second electrode, the electron emission layer is not formed on a part of the second electrode opposite to a part of the first electrode on which the electron emission layer is formed, and the electron emission layer is alternately formed on a part of the at least one second electrode opposite to a part of the first electrode on which the electron emission layer is not formed.

According to another aspect of the present invention, there is provided an electron emission type backlight unit including: the electron emission device; and an anode; a phosphor layer disposed between the electron emission device and the anode, wherein the anode accelerates electrons emitted from the electron emission device towards the phosphor layer.

According to another aspect of the present invention, there is provided a method of fabricating an electron emission device, including: forming first electrodes and second electrodes on a base substrate; forming a resistance layer on one or each of the first electrodes and the second electrodes; and forming an electron emission layer on the resistance layer.

The forming the resistance layer includes: depositing a material for forming the resistance layer so as to cover the base substrate, the first electrodes and the second electrodes, and patterning the material for forming the resistance layer to form the resistance layer on a predetermined parts of one or each of the first electrodes and the second electrodes.

The forming the resistance layer may include: forming a UV blocking layer so as to cover the base substrate, the first electrodes and second electrodes except parts on which the resistance layer is to be formed; applying a composition for forming the resistance layer so as to cover the UV blocking layer and the parts on which the resistance layer is to be formed; hardening the compositions for forming the resistance layer in areas corresponding to the parts using an exposure method; removing the compositions for forming the resistance layer except the hardened part; and removing the UV blocking layer.

The forming the electron emission layer may include applying a composition for forming an electron emission layer on parts on which the electron emission layer is to be formed using an ink jet method to form the electron emission layer.

The forming the electron emission layer may include forming a UV blocking layer so as to cover the base substrate, the first electrodes and the second electrodes except for parts on which an electron emission layer is to be formed; applying a composition for forming the electron emission layer so as to entirely cover the UV blocking layer and the parts; hardening the compositions for forming the electron emission layer in areas corresponding to the parts using an exposure method; removing the compositions for forming the electron emission layer except for the hardened parts; and removing the UV blocking layer.

The forming the resistance layer and the forming the electron emission layer may be combined and include forming a UV blocking layer so as to cover the base substrate, the first electrode and the second electrode except for a part on which the resistance layer and the electron emission layer are to be formed; applying a composition for forming the resistance layer so as to cover the UV blocking layer and the parts; applying a composition for forming the electron emission layer on the composition for forming the resistance layer; hardening the composition for forming the resistance layer and the composition for forming the electron emission layer in areas corresponding to the parts on which the resistance layer and the electron emission layer are to be formed using an exposure method; removing the compositions for forming the resistance layer and the compositions for forming the electron emission layer except for the hardened parts; and removing the UV blocking layer.

The compositions for forming the electron emission layer may include carbide-derived carbon.

The mean diameter of nanopores formed in the carbide-derived carbon may be in the range of 0.4 through 5 nm.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial cross-sectional view illustrating a conventional electron emission type backlight unit including an electron emission device;

FIG. 2 is a partial perspective view illustrating an electron emission device according to aspects of the present invention;

FIG. 3 is a cross-sectional view of an electron emission type backlight unit including the electron emission device of FIG. 2;

FIGS. 4 through 8 are cross-sectional views illustrating a method of fabricating an electron emission device according to aspects of the present invention;

FIGS. 9 through 16 are cross-sectional views illustrating a method of fabricating an electron emission device according to another aspect of the present invention; and

FIGS. 17 through 22 are cross-sectional views illustrating a method of fabricating an electron emission device according to another aspect of the present invention.

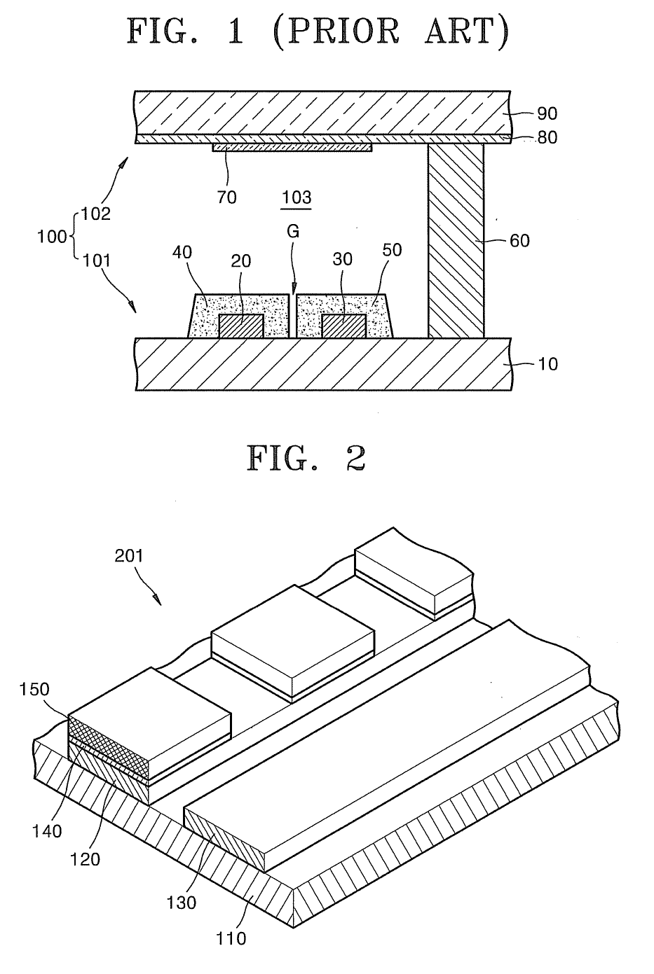

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Herein, when a layer is said to be “disposed on” another layer or a substrate, the phrase refers to a layer that may be directly formed on the other layer, or that a third layer may be disposed therebetween. In addition, the thickness of layers and regions may be exaggerated for clarity.

FIG. 2 is a partial perspective view illustrating an electron emission device 201 according to aspects of the present invention. Referring to FIG. 2, the electron emission device 201 includes a base substrate 110, a plurality of first electrodes 120, a plurality of second electrodes 130 and a plurality of electron emission layers 150. The base substrate 110 is a plate-like member having a predetermined thickness. The base substrate 110 may be formed of quartz glass, glass including a small quantity of impurities such as Na, or plate glass. The base substrate 110 may be a glass substrate including SiO₂ coated thereon, an oxide aluminum substrate, or a ceramic substrate. In addition, when the base substrate 110 is used in flexible display apparatuses, the base substrate 110 may be formed of flexible materials.

The first electrodes 120 and the second electrodes 130 are spaced at predetermined intervals and extend in one direction on the base substrate 110. The first electrodes 120 and the second electrodes 130 may be formed of conductive materials. For example, the first electrodes 120 and the second electrodes 130 may be formed of a metal such as Al, Ti, Cr. Ni, Au, Ag, Mo, W, Pt, Cu, Pd, or the like, or an alloy thereof. Or alternatively, the first electrodes 120 and the second electrodes 130 may be formed of a metal such as Pd, Ag, RuO₂, Pd—Ag, or the like, or a printed conductor including metal oxide and glass. In addition, the first electrodes 120 and the second electrodes 130 may be formed of a transparent conductor, or semiconductor material such as polysilicon, or the like.

The electron emission layers 150 are formed to be electrically connected to the first electrodes 120. The electron emission layers 150 include carbide-derived carbon as an electron emission material. The carbide-derived carbon includes a plurality of nanopores having an average diameter between about 0.2 through 10 nm. The carbide-derived carbon is formed of carbon. The average diameter of the nanopores may be between about 0.4 through 5 nm. When the electron emission layers 150 including the carbide-derived carbon are formed on a cathode and an anode is formed opposite the cathode, electrons may be emitted from the carbide-derived carbon towards the anode. The nanopores, which are formed in a surface of and/or throughout the carbide-derived carbon, function as electron paths. This phenomenon is similar to a point discharge in which a tiny device such as a nanotube emits electrons when an electric field is generated in a large nanomaterial. The carbide-derived carbon has an opposite shape to a carbon nanotube. However, the carbon-derived carbon is similar to the carbon nanotube in that when an electric field is generated in the carbide-derived carbon, the carbide-derived carbon emits electrons. A method of fabricating the carbide-derived carbon and a method of forming the carbide-derived carbon as an electron emission layer will be described later.

A resistance layer 140 is formed between the electron emission layers 150 and the first electrodes 120. The resistance layer 140 lowers an overall voltage level and decreases a voltage difference applied to each of the electron emission layers 150. The resistance layer 140 is formed of amorphous silicon, a semiconductor carbon nanotube, or the like.

In FIG. 2, the electron emission layers 150 included in the electron emission device 201 are formed on the first electrodes 120 at predetermined intervals. However, the electron emission layers 150 may be formed to entirely cover the first electrodes 120. In addition, in FIG. 2, the electron emission layers 150 are formed on only the first electrodes 120. However, the electron emission layers 150 may also be formed on the second electrodes 130. In this case, the electron emission layers 150 may not be formed on the second electrodes 130 directly opposite to the first electrode 120 on which the electron emission layers 150 are formed. The electron emission layers 150 may be formed on the second electrodes 130 directly opposite to the first electrodes 120 on which the electron emission layers 150 are not formed. In this structure, since the first electrodes 120 and the second electrodes 130 may alternately share functions, the lifetime of the electron emission device 201 may be doubled or more.

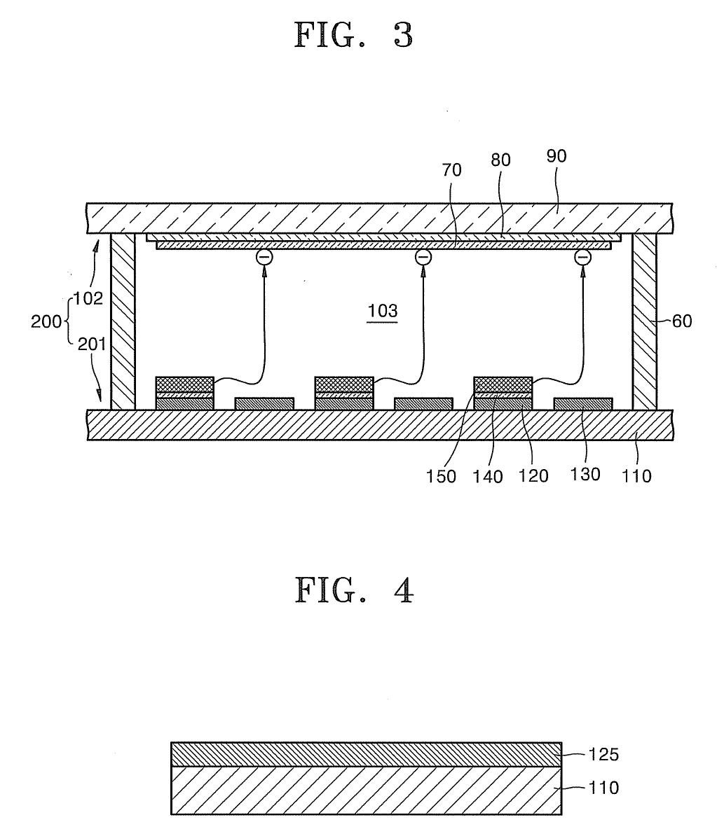

FIG. 3 is a cross-sectional view of an electron emission type backlight unit 200 including the electron emission device 201 of FIG. 2, according to aspects of the present invention.

Referring to FIG. 3, the electron emission type backlight unit 200 includes the electron emission device 201 and a front panel 102 arranged in front of the electron emission device 201. The electron emission device 201 has already been described with reference to FIG. 2, and thus, a detailed description thereof will be omitted.

The front panel 102 includes a front substrate 90 to transmit visible rays, a phosphor layer 70 which is formed on the front substrate 90 and excited by electrons emitted from the electron emission device 201 to emit visible rays, and an anode electrode 80, disposed between the front substrate 90 and the phosphor layer 70. The anode electrode 80 accelerates electrons emitted from the electron emission device 201 towards the phosphor layer 70.

The front substrate 90 may be formed of the same material as that of the base substrate 110, and may transmit visible rays. The anode electrode 80 may be formed of the same material as that of the first electrodes 120 and the second electrodes 130.

The phosphor layer 70 is formed of a cathode luminescence (CL) type fluorescent material excited by the accelerated electrons to emit visible rays. For example, the fluorescent material used in the phosphor layer 70 may be a red fluorescent material including SrTiO₃:Pr, Y₂O₃:Eu, Y₂O₃S:Eu, or the like, a green fluorescent material including Zn(Ga, Al)₂O₄:Mn, Y₃(Al, Ga)₅O₁₂:Tb, Y₂SiO₅:Tb, ZnS:Cu, Al, or the like, and/or a blue fluorescent material including Y₂SiO₅:Ce, ZnGa₂O₄, ZnS:Ag, Cl, or the like, but is not limited thereto. The phosphor layer 70 may include red, green, and blue fluorescent materials arranged so that the red, green, and blue fluorescent materials may be individually or simultaneously excited to produce full color static or dynamic images. Further, the electron emission layers 150 may be disposed along the first and/or second electrodes 120 and 130 so as to produce electron emissions specifically in one of the red, green, and blue fluorescent materials.

So that the electron emission type backlight unit 200 may be normally driven, a vacuum should be maintained in the space between the phosphor layer 70 and the electron emission device 201. Accordingly, the electron emission type backlight unit 200 may further include spacers 60 to maintain the interval between the phosphor layer 70 and the electron emission device 201 and glass frit (not shown) that seals the vacuum space. The glass frit is arranged around the vacuum space to seal the vacuum space.

The electron emission type backlight unit 200 is driven as follows. Negative (−) and positive (+) voltages are applied to the first electrodes 120 and the second electrodes 130 formed on the electron emission device 201, respectively. Accordingly, by electric fields generated between the first electrodes 120 and the second electrodes 130, the electron emission layers 150 emit electrons towards the second electrodes 130. Here, when a positive (+) voltage much greater than that applied to the second electrodes 130 is applied to the anode electrode 80, electrons emitted from the electron emission layers 150 are accelerated towards the anode electrode 80. The electrons collide with and excite the phosphor layer 70 formed on the anode electrode 80 which then emits visible rays. Electron emission can be controlled by the voltage applied to the second electrodes 130.

However, negative (−) voltage does not have to be applied to the first electrodes 120. Only a voltage potential sufficient to emit electrons needs to be generated between the first electrodes 120 and the second electrode 130.

In FIG. 3, the electron emission type backlight unit 200 is a surface light source. The electron emission type backlight unit 200 may be used as the backlight unit of a non-emissive display device such as a TFT-LCD. In order to display images, instead of simply emitting a visible rays from the surface light source, or in order to use a backlight unit having a dimming function, the first electrodes 120 and the second electrodes 130 included in the electron emission device 201 may be alternately formed. Accordingly, one of or both of the first electrodes 120 and the second electrodes 130 may be formed to have a main electrode part and a branch electrode. The main electrode parts of the first and second electrodes 120 and 130 are alternately formed. The branch electrodes extend from the main electrode parts of one of the first and second electrodes 120 and 130 toward the other of the first and second electrodes 120 and 130. The electron emission layers 150 may be formed on the branch electrodes or a part facing the branch electrode. Additionally, each of the first and second electrodes 120 and 130 may have branch electrode parts that extend toward the other of the first and second electrodes 120 and 130 such that the branch electrode parts of the first and second electrodes 120 and 130 extend toward the branch electrode parts of the other of the first and second electrodes 120 and 130 or extend toward the main electrode parts of the other of the first and second electrodes 120 and 130. Further, the branch electrode parts of the first and second electrodes 120 and 130 may have different shapes, including an I-shape or a T-shape. And, the electron emission layers 150 may be formed on one or both of the first and second electrodes 120 and 130, may be formed oppositely or alternately on the first and second electrodes 120 and 130, and may be formed on one or both of the main electrode and branch electrode parts of the first and second electrodes 120 and 130. The spacers 60 may form pixels of varying shapes in which the phosphor layers 70 are disposed. In such case, the phosphor layers 70 may include red, green, and blue fluorescent materials in the same or respective pixels.

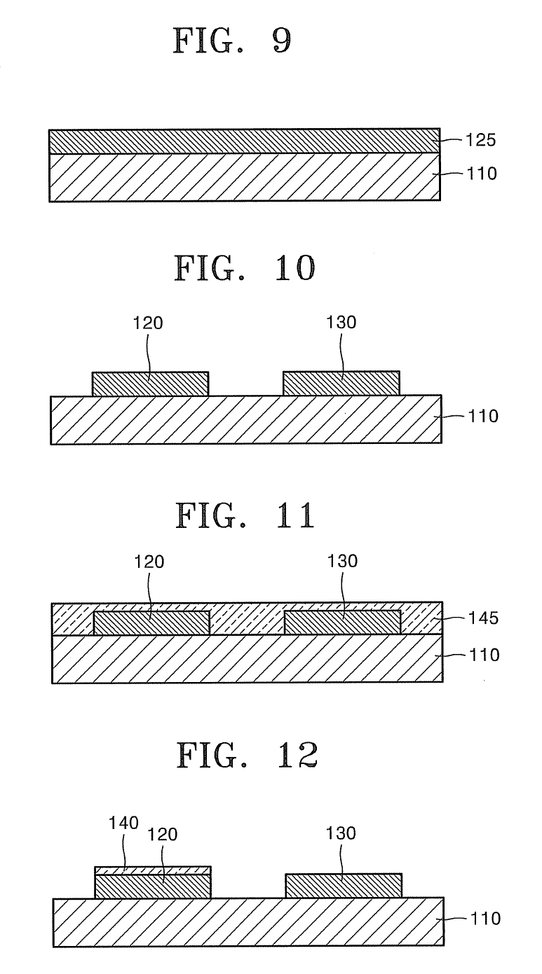

Hereinafter, a method of fabricating an electron emission device according to an aspect of the present invention will be described. The method of fabrication the electron emission device includes forming an electron emission layer by applying a composition for forming an electron emission layer including carbide-derived carbon to a substrate using an inkjet method or a print method. First, a method of fabricating the compositions for forming the electron emission layer including carbide-derived carbon will be described. Then, the method of fabricating an electron emission device will be described referring to FIGS. 4 through 22.

An electron emission device may be fabricated with the compositions for forming an electron emission layer using an inkjet method or a print method. The inkjet method comprises simpler operations and remarkably less manufacturing costs than a chemical vapor deposition (CVD) method and a print method, in both of which conventional carbon nanotubes are used as a main element of an electron emission layer. The print method is similar to a method in which conventional carbon nanotubes are used. However, since the dispersibility of carbide-derived carbon is greater than carbon nanotubes, the electron emission layer can be more easily formed even when using the print method with the carbide-derived carbon than the print method using the carbon nanotubes.

The compositions for forming the electron emission layer include carbide-derived carbon, organic solvent, and a disperser. The carbide-derived carbon can be prepared by a thermochemical reaction between a carbide compound and a halogen-group-containing gas that extracts all elements except the carbon included in the carbide compound.

As disclosed in international publication WO 1998/54111, carbide-derived carbon having nanoporosity throughout the entire work piece can be prepared using a method including (1) forming the work piece of the halogen group element having a predetermined transport porosity in particles of the carbide-derived carbon, and (2) thermochemically treating the work piece of the halogen group element containing gas at a temperature in the range of about 350 through 1200° C. to extract all elements except carbon from the work piece.

The carbide-derived carbon is more appropriate for forming an electron emission layer using the inkjet method than carbon nanotubes used in conventional electron emitters. Carbon nanotubes have a fiber-type structure with a high aspect ratio, but the carbide-derived carbon forms a plate-type structure with an aspect ratio of about 1 to have a very small field enhancement factor β. In addition, the size of the final electron emission material is easily controlled by selectively applying carbide as a precursor of the electron emission material.

The carbide compound may be a compound of carbon and a Group III, IV, V, or VI element. Preferably, the carbide compound may be a diamond-based carbide such as SiC₄, B₄C or Mo₂C; a metal-based carbide such as TiC or ZrCₓ; a salt-based carbide such as Al₄C₃ or CaC₂; a complex carbide such as TiₓTa_{y}C or MoₓW_{y}C; a carbonitride such as TiNₓC_{y} or ZrNₓC_{y}; a mixture of the carbide materials, or the like. The halogen-group-containing gas may be Cl₂ (chloride), TiCl₄, F₂, Br₂, I₂, HCl or the like, or a mixture thereof.

In addition, the compositions for forming the electron emission layer include a disperser. The disperser may be at least one compound selected from the group consisting of alkylamine, carboxylic acid amid, and amino carboxylic acid salt.

The organic solvent included in the compositions for forming the electron emission layer may be a typical organic solvent appropriate for the ink jet method. The organic solvent may be at least one selected from the group consisting of linear alkanes, such as hexane, heptane, octane, decane, undecane, dodecane, tridecane, trimethylpentane, or the like; ring-shaped alkanes such as cyclohexane, cycloheptane, cycloctane, or the like; aromatic hydrocarbons such as benzene, toluene, xylene, trimethylbenzene, dodecylbenzene, or the like; and alcohols such as hexanol, heptanol, octanol, decanol, cyclohexanol, terpineol, citronellol, geraniol, phenethyl alcohol, or the like. The examples of the organic solvent are used separately or mixed.

The compositions for forming the electron emission layer may further include organic/inorganic additives in addition to carbide-derived carbon, disperser, and organic solvent.

The compositions for forming the electron emission layer may be prepared using a method including agitation, ultrasonic treatment, grinding, and a sand meal process of high dispersible suspension of carbide derived carbon, a disperser, and organic solvent, and mixing and re-agitating the organic/inorganic binder and other organic/inorganic additives. In contrast, the compositions for forming the electron emission layer may be prepared by simultaneously mixing all elements.

As the electron emission layer is fabricated using the ink jet method in which an additional patterning operation is not required, the number of processing steps and the materials can be reduced. In addition, irregular emission can be prevented. Here, irregular emission occurs due to selvage generated using the conventional printing method. Since the plate-like carbide-derived carbon is used in the method of fabricating the electron emission layer, the ink jet method can be easily used to fabricate the electron emission layer. In addition, a minute electron emission layer can be conveniently fabricated. In the minute electron emission layer, an arc discharge does not occur even in a high electric field.

Hereinafter, methods of fabricating an electron emission device according to aspects of the present invention will be described with reference to FIGS. 4 through 22.

FIGS. 4 through 8 are cross-sectional views illustrating a method of fabricating an electron emission device according to aspects of the present invention.

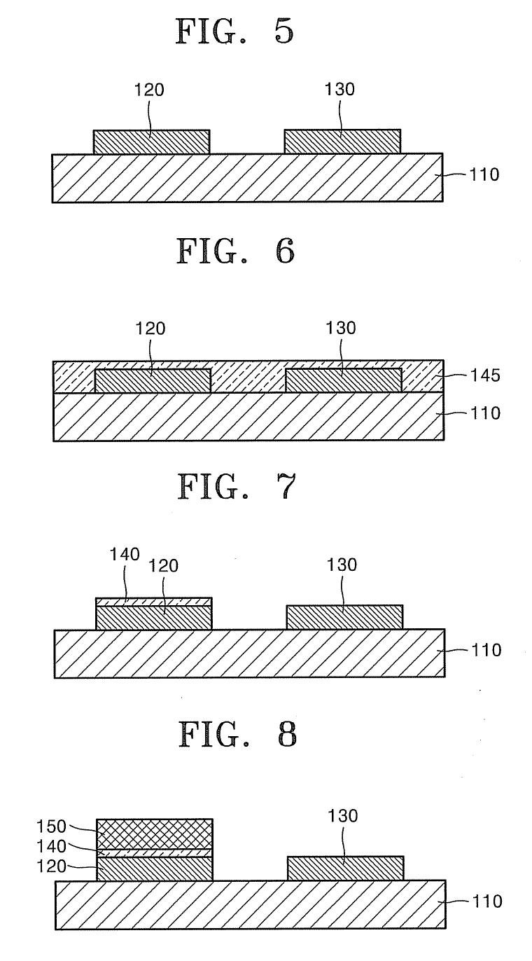

An electrode material 125 is deposited on a base substrate 110 (FIG. 4) using a deposition method, or the like, when the electrode material 125 is a metal. The electrode material 125 is patterned to form a first electrode 120 and a second electrode 130 (FIG. 5). A resistance layer material 145 for forming a resistance layer is deposited so as to cover the base substrate 110 and the first and second electrodes 120 and 130 (FIG. 6). The resistance layer material 145 is patterned to form a resistance layer 140 that remains on only one of the first and second electrodes 120 and 130 (FIG. 7). Compositions (not shown) for forming an electron emission layer are applied to the first and second electrodes 120 and 130 on which the resistance layer 140 is formed using an ink jet method. An electron emission layer 150 is formed on the resistance layer 140 to thereby complete the manufacture of an electron emission device (FIG. 8).

The method of fabricating the electron emission device as illustrated in FIGS. 4 through 8 is different from the following two methods in that the electron emission layer 150 illustrated in FIG. 8 is formed using an ink jet method. However, the compositions for forming the electron emission layer 150 may be common to all of the descriptions contained herein. Mixing rates of the compositions for forming the electron emission layer 150 or additional elements used in the ink jet method and the print method using a paste may be different. Accordingly, physical properties such as viscosity, or the like, of the compositions for forming the electron emission layer 150 according to the current embodiment of the present invention may be different from those of the other descriptions herein.

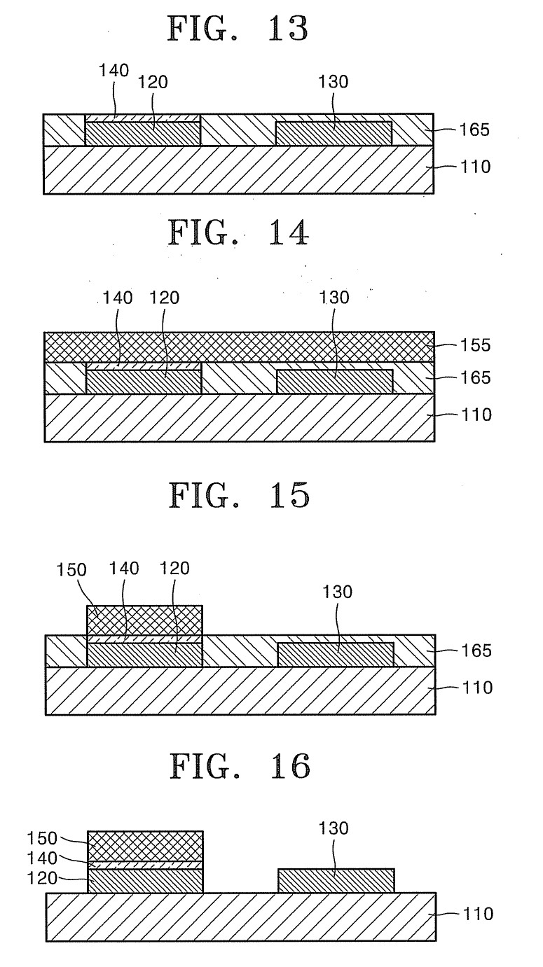

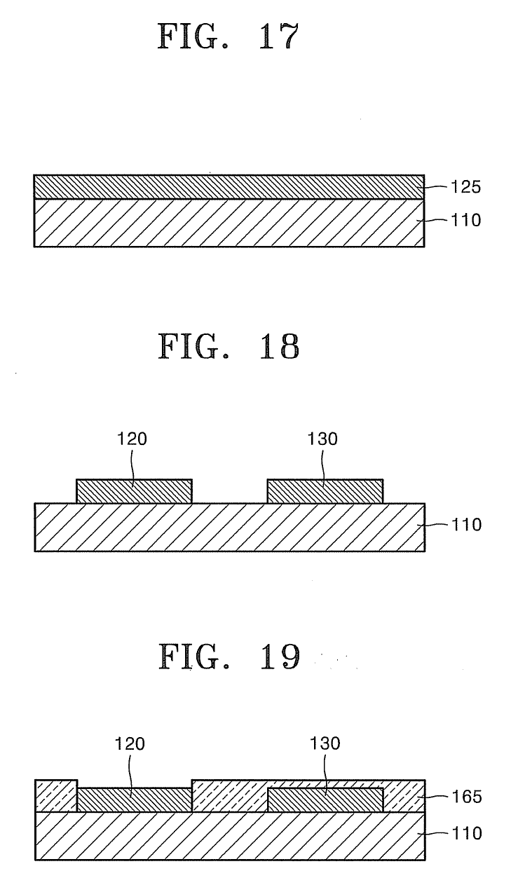

FIGS. 9 through 16 are cross-sectional views illustrating a method of fabricating an electron emission device according to another aspect of the present invention. The operations of FIGS. 9 through 12 are the same as those of FIGS. 4 through 7 in that a first electrode 120 and a second electrode 130 are first formed on a base substrate 110, and a resistance layer 140 is formed on either of the first electrode 120 and the second electrode 130. Referring to FIG. 13, a UV blocking layer 165 is formed on the base substrate 110, the first electrode 120, the second electrode 130, and the resistance layer 140, except for a part on which an electron emission layer is to be formed. Compositions 155 for forming an electron emission layer 150 including carbide-derived carbon are applied to the entire area of the base substrate 110 including the UV blocking layer 165 (FIG. 14). An ultra-violet front-exposure is performed to harden only the portion of the compositions 155 for forming an electron emission layer 150 in which an electron emission layer 150 is to be formed. Next, the unhardened or unexposed portions of the compositions 155 are developed and removed to form the electron emission layer 150 (FIG. 15). The UV blocking layer 165 is removed using a method such as etching or the like to thereby complete the manufacture of an electron emission device (FIG. 16). The compositions 155 for forming the electron emission layer 150 may include photosensitive resin having a negative sensitivity to UV rays such that the compositions 155 for forming the electron emission layer 150 is hardened by UV rays.

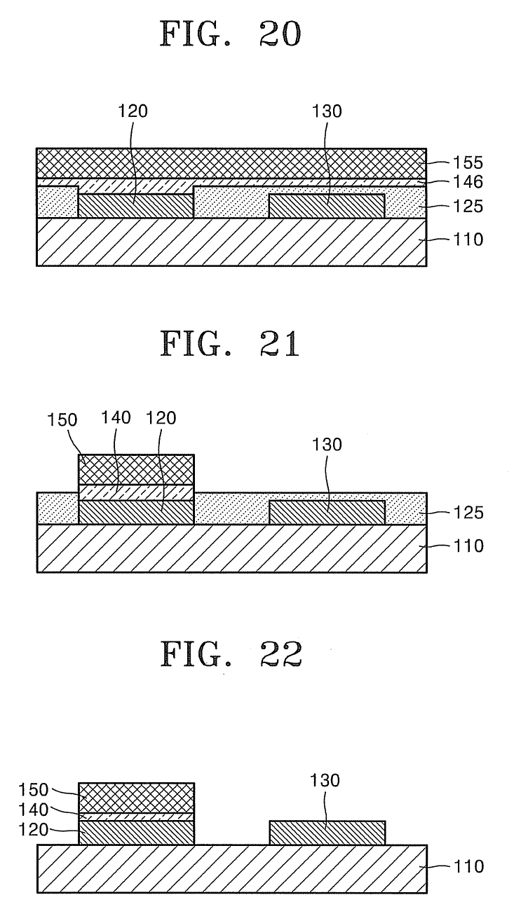

FIGS. 17 through 22 are cross-sectional views illustrating a method of fabricating an electron emission device according to another aspect of the present invention. An electrode material 125 is deposited on a base substrate 110 (FIG. 17) using a deposition method, or the like, when the electrode material 125 is a metal. The electrode material 125 is patterned to form a first electrode 120 and a second electrode 130 (FIG. 18). Referring to FIG. 19, a UV blocking layer 165 is formed to cover all parts of the first and second electrodes 120 and 130 except a part on which a resistance layer is to be formed. Compositions 146 for forming a resistance layer 140 are coated on the entire area of the base substrate 110 including the UV blocking layer 165. Compositions 155, including carbide-derived carbon, for forming an electron emission layer 150 are applied to the compositions 146 for forming a resistance layer 140 (FIG. 20).

The compositions 146 for forming a resistance layer 140 may include amorphous silicon, semiconductor carbon nanotubes, organic solvent for changing states of the amorphous silicon and semiconductor carbon nanotubes to a paste state, a disperser, a photosensitive resin having negative sensitivity, or the like. An ultra-violet front-exposure is performed to harden only the portions of the compositions 155 for forming an electron emission layer 150 in which electron emission layers 150 and resistance layers 140 are to be formed. Next, the unhardened or unexposed parts are developed and removed to form an electron emission layer 150 and a resistance layer 140 (FIG. 21). The UV blocking layer 165 is removed using a method such as etching, or the like, to thereby complete the manufacture of an electron emission device (FIG. 22). The compositions 155 and 146 for forming the electron emission layer 150 and the resistance layer 140, respectively, may include photosensitive resins having negative sensitivities to the UV rays such that the compositions 155 and 146 for forming the electron emission layer 150 and the resistance layer 140 are hardened by the UV rays.

The electron emission device according to aspects of the present invention and an electron emission display device including the electron emission device are manufactured using a simplified manufacturing process, thus improving efficiency. In addition, the electron emission efficiency of a thin film layer of carbide-derived carbon is good. Thus, the carbide-derived carbon thin film layer can save energy and increase brightness.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission device, comprising:
a first electrode;
a second electrode formed opposite the first electrode; and
an electron emission layer comprising carbide-derived carbon and electrically connected to one or each of the first and second electrodes.

2. The electron emission device of claim 1, wherein a mean diameter of nanopores formed in the carbide-derived carbon is between about 0.4 through 5 nm.

3. The electron emission device of claim 1, further comprising:
a resistance layer which is disposed between the electron emission layer and the one or each of the first and second electrodes electrically connected to the electron emission layer.

4. The electron emission device of claim 1, wherein the resistance layer comprises amorphous silicon or semiconductor carbon nanotubes.

5. The electron emission device of claim 1, wherein the electron emission layer is intermittently formed at predetermined intervals on one or each of the first electrode and the second electrode.

6. The electron emission device of claim 1, wherein the electron emission layer is intermittently formed at predetermined intervals on one or each of the first electrode and the second electrode,
the electron emission layer is not formed on a part of the second electrode opposite to a part of the first electrode on which the electron emission layer is formed, and
the electron emission layer is alternately formed on a part of the second electrode opposite to a part of the first electrode on which the electron emission layer is not formed.

7. An electron emission type backlight unit, comprising:
the electron emission device of claim 1;
an anode; and
a phosphor layer disposed between the electron emission device and the anode,
wherein the anode accelerates electrons emitted from the electron emission device toward the phosphor layer.

8. A method of fabricating an electron emission device, comprising:
forming a first electrode and a second electrode on a base substrate;
forming a resistance layer on one or each of the first electrode and the second electrode; and
forming an electron emission layer on the resistance layer.

9. The method of claim 8, wherein the forming the resistance layer comprises:
depositing a material for forming the resistance layer so as to cover the base substrate, the first electrode, and the second electrode; and
patterning the material for forming the resistance layer to form the resistance layer on predetermined parts of one or each of the first electrode and the second electrode.

10. The method of claim 8, wherein the forming the resistance layer comprises:
forming a UV blocking layer so as to cover the base substrate, the first electrode and second electrode except for parts on which the resistance layer is to be formed;
applying a composition for forming the resistance layer so as to cover the UV blocking layer and the parts on which the resistance layer is to be formed;
hardening the composition for forming the resistance layer in areas corresponding to the parts using an exposure method;
removing the composition for forming the resistance layer except the hardened part; and
removing the UV blocking layer.

11. The method of claim 8, wherein the forming the electron emission layer comprises:
applying a composition for forming an electron emission layer on parts on which the electron emission layer is to be formed using an ink jet method to form the electron emission layer.

12. The method of claim 8, wherein the forming the electron emission layer comprises:
forming a UV blocking layer so as to cover the base substrate, the first electrode, and the second electrode except for parts on which an electron emission layer is to be formed;
applying a composition for forming the electron emission layer so as to entirely cover the UV blocking layer and the parts;
hardening the composition for forming the electron emission layer in areas corresponding to the parts using an exposure method;
removing the composition for forming the electron emission layer except for the hardened parts; and
removing the UV blocking layer.

13. The method of claim 8, wherein the forming the resistance layer and the forming the electron emission layer are combined and comprise:
forming a UV blocking layer so as to cover the base substrate, the first electrode, and the second electrode except for parts on which the resistance layer and the electron emission layer are to be formed;
applying a composition for forming the resistance layer so as to cover the UV blocking layer and the parts;
applying a composition for forming the electron emission layer on the composition for forming the resistance layer;
hardening the composition for forming the resistance layer and the composition for forming the electron emission layer in areas corresponding to the parts on which the resistance layer and the electron emission layer are to be formed using an exposure method;
removing the compositions for forming the resistance layer and the compositions for forming the electron emission layer except for the hardened parts; and
removing the UV blocking layer.

14. The method of claim 8, wherein the compositions for forming the electron emission layer comprise carbide-derived carbon.

15. The method of claim 14, wherein the mean diameter of nanopores formed in the carbide-derived carbon is in the range of 0.4 through 5 nm.

16. The method of claim 8, wherein the forming the resistance layer comprises:
intermittently forming a first portion of the resistance layer on the first electrode; and
intermittently forming a second portion of the resistance layer on the second electrode,
wherein the second portion is formed on the second electrode corresponding to areas of the first electrode in which the first portion is not formed.

17. The method of claim 8, the forming the first electrode and the second electrode further comprises:
repeatedly forming the first electrode and the second electrode on the base substrate to form plural numbers of the first electrode and the second electrode.
